(19) United States
(12) Patent Application Publication
(10) Pub. No.: US 2019/0372382 A1
(43) Pub. Date: Dec. 5, 2019

(54) DC CHARGING SYSTEM FOR STORAGE BATTERY OF ELECTRIC VEHICLE

(71) Applicants: Luoliang Xue, Henan (CN); Chan Xue, Henan (CN)

(72) Inventors: Luoliang Xue, Henan (CN); Chan Xue, Henan (CN)

(21) Appl. No.: 15/995,670

(22) Filed: Jun. 1, 2018

(51) Int. Cl. H02J 7/00; H02M 3/335; B60L 11/18

(52) U.S. Cl. CPC H02J 7/0093; H02M 3/335; B60L 11/185; B60L 11/1825; H02J 7/0027

(57) ABSTRACT

A direct-current (DC) charging system is provided for a storage battery of an electric vehicle. The charging system includes a distribution transformer and a DC charging pile. The DC charging pile includes a charging pile controller and a step-down high-frequency PWM rectification filter circuit. The charging system according to this invention can reduce complexity of the structure and circuits of a charging pile, and decrease the energy consumption of the device, thus reducing the operational costs.

### TECHNICAL FIELD

The present invention relates to storage battery charging technology, and in particular, to a direct-current (DC) charging system for a storage battery such as those used with an electric vehicle.

### BACKGROUND

A DC charging device is required to meet a rapid charging requirement for a storage battery of an electric vehicle. At present, a DC charging pile uses a switching power supply. Affected by properties of electronic components, an individual switching power supply has a relatively small capacity, failing to meet the rapid charging requirement for a large-capacity storage battery. Therefore, a conventional DC charging pile is formed by multiple parallel-connected switching power supplies, and a control device distributes power among the parallel-connected switching power supplies according to the storage battery charging requirement. The switching power supply uses Boost rectification to electrically isolate inputs and outputs with a high-frequency transformer. The foregoing conventional device uses a lot of power electronic components of which the wiring is complex, and has high energy consumption, resulting in high costs.

Accordingly, it would be desirable to improve upon the conventional devices used for charging storage batteries such as those used with an electric vehicle, to thereby improve cost-effectiveness and speed of the charging process.

### SUMMARY

The present disclosure provides a DC charging system for a storage battery of an electric vehicle, which can reduce complexity of the structure and circuits of a charging pile, and decrease the energy consumption of the device, thus reducing the costs.

To this end, a DC charging system for a storage battery of an electric vehicle according to one embodiment of the invention includes a distribution transformer and a DC charging pile, where the distribution transformer includes a primary high-voltage side and a secondary low-voltage side, and the DC charging pile includes a charging pile controller and a step-down high-frequency PWM rectification filter circuit. The step-down high-frequency PWM rectification filter circuit includes a filter, a rectifier bridge, and a filter loop, the filter including a filter inductor and an energy storage capacitor. The rectifier bridge includes six rectifier arms and each rectifier arm is formed by connecting a switch transistor in series with a diode. The filter loop includes a flyback diode, an energy storage inductor and a filter capacitor. The primary high-voltage side is connected to a public medium-voltage distribution network. The secondary low-voltage side is connected to an input end of the step-down high-frequency PWM rectification filter circuit, to supply power to the step-down high-frequency PWM rectification filter circuit; and an output end of the step-down high-frequency PWM rectification filter circuit is connected to a charge interface of the DC charging pile. A positive output end of the rectifier bridge is connected to a negative electrode of the flyback diode and one end of the energy storage inductor, the other end of the energy storage inductor is connected to a positive electrode of the filter capacitor, and a negative output end of the rectifier bridge is connected to a positive electrode of the flyback diode and a negative electrode of the filter capacitor. An output end of the charging pile controller is connected to the switch transistors by an isolation drive, to control switch-on/switch-off of the switch transistors in the step-down high-frequency PWM rectification filter circuit.

In one aspect, the output end of the charging pile controller is connected to gate electrodes of the switch transistors.

In another aspect, the secondary low-voltage side is provided with at least one three-phase secondary winding.

In a further aspect, a voltage of the low-voltage side of the three-phase secondary winding equals to a non-standard voltage value.

The DC charging system of this invention achieves several advantages and technical effects. In this regard, the DC charging system uses a combination of a distribution transformer and a step-down high-frequency PWM rectification filter circuit, and therefore avoids the use of a high-frequency transformer for a switching power supply, thus decreasing the number of components and reducing investment on a charging device. A voltage input to the step-down high-frequency PWM rectification filter circuit is relatively high, such that the current through the switch transistor and the diode loop is reduced, thus reducing the energy consumption of the device. Moreover, a capacity can be expanded by connecting multiple groups of rectifier circuits (Buck) in parallel.

### BRIEF DESCRIPTION OF THE DRAWING

Various additional features and advantages of the invention will become more apparent to those of ordinary skill in the art upon review of the following detailed description of one or more illustrative embodiments taken in conjunction with the accompanying drawing. The accompanying drawing, which is incorporated in and constitute a part of this specification, illustrates one or more embodiments of the invention and, together with the general description given above and the detailed description given below, explains the one or more embodiments of the invention.

FIG. 1 is a schematic structural diagram of a DC charging system for a storage battery of an electrical vehicle according to one embodiment of the invention.

### DETAILED DESCRIPTION

Embodiments of the invention are illustrated below with reference to the accompanying drawings. The preferred embodiments described here are used only to describe and explain the present disclosure, but not to limit the present disclosure.

The DC charging system for a storage battery of an electric vehicle according to this invention reduces complexity of the structure and circuits of a charging pile, and decreases the energy consumption of the device, thus reducing the costs of operation.

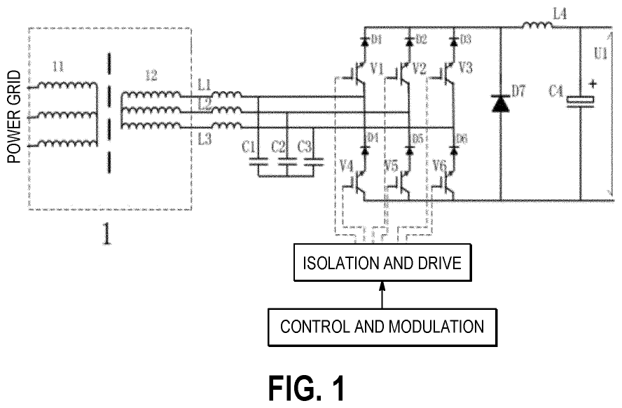

With reference to the drawing, FIG. 1 is a schematic structural diagram of a DC charging system for a storage battery of an electrical vehicle according to a first embodiment of the invention. As shown in FIG. 1, the DC charging system for a storage battery of an electrical vehicle includes a distribution transformer and a DC charging pile.

The distribution transformer 1 includes a primary high-voltage side 11 and a secondary low-voltage side 12, and the DC charging pile includes a charging pile controller and a step-down high-frequency PWM rectification filter circuit.

The step-down high-frequency PWM rectification filter circuit includes a filter, a rectifier bridge, and a filter loop. The filter includes filter inductors L1, L2, and L3 and energy storage capacitors C1, C2, and C3. The rectifier bridge includes six rectifier arms and each rectifier arm is formed by connecting a switch transistor V1, V2, V3, V4, V5 and V6 in series with a rectifier diode D1, D2, D3, D4, D5 and D6. The filter loop includes a flyback diode D7, an energy storage inductor L4 and a filter capacitor C4.

The primary high-voltage side 11 is connected to a public medium-voltage distribution network. The secondary low-voltage side 12 is connected to an input end of the step-down high-frequency PWM rectification filter circuit, to supply power to the step-down high-frequency PWM rectification filter circuit; and an output end of the step-down high-frequency PWM rectification filter circuit is connected to a charge interface of the DC charging pile.

A positive output end of the rectifier bridge is connected to a negative electrode of the flyback diode D7 and one end of the energy storage inductor L4, and the other end of the energy storage inductor L4 is connected to a positive electrode of the filter capacitor C4. A negative output end of the rectifier bridge is connected to a positive electrode of the flyback diode D7 and a negative electrode of the filter capacitor C4.

An output end of the charging pile controller is connected to the switch transistors V1, V2, V3, V4, V5 and V6 via an isolation-driven loop, to control switch-on/switch-off of the switch transistors V1, V2, V3, V4, V5 and V6 in the step-down high-frequency PWM rectification filter circuit.

The output end of the charging pile controller is connected to gate electrodes of the switch transistors V1, V2, V3, V4, V5, and V6 by an isolation drive.

The secondary low-voltage side 12 is provided with at least one three-phase secondary winding.

A voltage of the low-voltage side of the three-phase secondary winding equals to a non-standard voltage value.

According to a first embodiment consistent with the elements shown in FIG. 1, one three-phase secondary winding is set on the secondary low-voltage side 12 of the distribution transformer. There is also provided a plurality of DC charging piles. The non-standard voltage value output by the secondary low-voltage side 12 can simultaneously meet a storage battery charging requirement, a power factor control requirement, and a grid voltage fluctuation requirement of 15%. A modulation wave output by the charging pile controller controls gate electrodes of the switch transistors V1, V2, V3, V4, V5 and V6. The magnitude of an output current of a rectifier circuit and an input power factor are controlled through PWM modulation. The filter circuit makes a current ripple achieve the storage battery charging requirement of the electric vehicle. Specifically, the charging pile controller modulates the carrier pulse width according to a storage battery charging policy and a power factor control requirement, to control switch-on/switch-off of the switch transistors V1, V2, V3, V4, V5 and V6 in the rectifier circuit. The entire DC charging system device charges the storage battery of the electric vehicle via an output terminal U1.

According to a second embodiment, one difference between this embodiment and the first described above is that a plurality of three-phase secondary windings is set on the secondary low-voltage side 12 of the distribution transformer. The number of the DC charging piles is the same as that of the three-phase secondary windings.

The present invention uses a combination of a step-down (Buck) high-frequency PWM rectifier device and a dedicated distribution transformer 1. A voltage of a low-voltage side of the distribution transformer equals to a non-standard voltage value and is used to supply power to the step-down (Buck) high-frequency PWM rectifier device. The voltage value simultaneously meets a storage battery charging requirement, a power factor control requirement, and a grid voltage fluctuation requirement of 15%. A charging current is output after rectification and filtering on the current at the low-voltage side of the distribution transformer, and thus the use of a high-frequency transformer for a switching power supply is avoided, decreasing the number of components and reducing investment on a charging device. A voltage input to the high-frequency PWM rectification circuit (Buck) is relatively high, such that the current through the switch transistors and a diode loop is reduced at the same power, thus reducing the overall energy consumption of the device. Moreover, a capacity can be expanded by connecting multiple groups of rectifier circuits (Buck) in parallel, and thus the structure of the charging pile can be simplified and the complexity of the circuits can be reduced, reducing the investment on pile construction.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the contents of this specification shall not be construed as a limitation to the invention.

What is claimed is:

1. A direct-current (DC) charging system for a storage battery of an electric vehicle, comprising:
a distribution transformer; and
a DC charging pile,
wherein the distribution transformer comprises a primary high-voltage side and a secondary low-voltage side, and the DC charging pile comprises a charging pile controller and a step-down high-frequency PWM rectification filter circuit;
wherein the step-down high-frequency PWM rectification filter circuit comprises a filter, a rectifier bridge, and a filter loop, the filter comprising a filter inductor and an energy storage capacitor; the rectifier bridge comprising six rectifier arms and each rectifier arm being formed by connecting a switch transistor in series with a rectifier diode; and the filter loop comprising a flyback diode, an energy storage inductor and a filter capacitor;
wherein the primary high-voltage side of the distribution transformer is connected to a public medium-voltage distribution network; the secondary low-voltage side is connected to an input end of the step-down high-frequency PWM rectification filter circuit, to supply power to the step-down high-frequency PWM rectification filter circuit; and an output end of the step-down high-frequency PWM rectification filter circuit is connected to a charge interface of the DC charging pile; and
wherein an output end of the charging pile controller is connected to the switch transistors by an isolation drive, to control switch-on/switch-off of the switch transistors in the step-down high-frequency PWM rectification filter circuit.

2. The DC charging system of claim 1, wherein the output end of the charging pile controller is connected to gate electrodes of the switch transistors by an isolation drive.

3. The DC charging system of claim 1, wherein a positive output end of the rectifier bridge is connected to a negative electrode of the flyback diode and one end of the energy storage inductor, another end of the energy storage inductor is connected to a positive electrode of the filter capacitor, and a negative output end of the rectifier bridge is connected to a positive electrode of the flyback diode and a negative electrode of the filter capacitor.

4. The DC charging system of claim 1, wherein the secondary low-voltage side is provided with at least one three-phase secondary winding.

5. The DC charging system of claim 4, wherein a voltage of the low-voltage side of the at least one three-phase secondary winding equals to a non-standard voltage value that simultaneously meets a storage battery charging requirement, a power factor control requirement, and a grid voltage fluctuation requirement of 15%.
